(19) United States
(12) Patent Application Publication
(10) Pub. No.: US 2010/0100235 A1
(43) Pub. Date: Apr. 22, 2010

(54) METHOD AND SYSTEM FOR SIMULTANEOUS BI-DIRECTIONAL CONVEYOR CONTROL FOR MOVING MATERIAL HOLDERS IN A FAB

(75) Inventor: Joseph John Fatula, III, Fremont, CA (US)

Correspondence Address: FISH & RICHARDSON PC, P.O. BOX 1022, MINNEAPOLIS, MN, 55440-1022, US

(73) Assignee: Asyst Technology, Inc., Fremont, CA (US)

(21) Appl. No.: 12/420,780

(22) Filed: Apr. 8, 2009

Related U.S. Application Data
(60) Provisional application No. 61/043,383, filed on Apr. 8, 2008.

(51) Int. Cl. B65G 49/07; B65G 43/08

(52) U.S. Cl. 700/230; 198/358

(57) ABSTRACT

A method for managing flow of containers over asynchronous conveyors used in semiconductor automated material handling systems (AMHS) is defined. The method includes providing a conveyor and enabling travel of a first container in a first direction on the conveyor and enabling travel of a second container in a second direction on the conveyor. The second direction being toward the first direction. The method also includes determining a destination of the first and second containers along the conveyor (e.g., such as a load port). The method then directions one of the first or second containers to reverse its direction to enable one of the first or second containers to arrive to its destinations. The directing acts to minimize travel or wait time of the first or second containers on the conveyor belt. The directing enables higher throughput on the conveyor and enables more than one container to travel on the conveyor at the same time.

### CLAIM OF PRIORITY

The present application claims priority under 35 U.S.C. §119(e) from U.S. Provisional Patent Application No. 61/043,383, filed Apr. 8, 2008, which is incorporated by reference in its entirety for all purposes.

### CROSS-REFERENCE TO RELATED APPLICATIONS

This application is related to U.S. application Ser. No. 11/484,218 (ASTGP135), which is incorporated in its entirely by reference herein.

### BACKGROUND

There are several ways that semiconductor wafer containers are transported in a semiconductor fabrication facility (“fab”). A system for transporting a container is often referred to as an Automated Material Transport System (“AMHS”) or simply as a material transport system. A material transport system may refer to a part or all of the overall system. A fab may use only one type of AMHS throughout the fab, or there may be different types of AMHS in certain areas, or different types of AMHS for different transportation functions. Some of these AMHS types use vehicles to hold the container as it is being transported, such as a rail guided vehicle (RGV) or an automated guided vehicle (AGV). Material transport systems utilizing RGVs or AGVs require managing empty vehicles to arrange their arrival at sites where containers are to be picked up. Waiting for the arrival of such vehicles causes AMHS delays and the management of the vehicle movement increases the complexity of the AMHS. The same issues exist when moving containers with an Overhead Hoist Transport (OHT) system.

Conveyor systems are more efficient at moving containers within a fab without any, or a minimum number of, vehicle delays, and do not have to manage empty vehicles. Conveyors directly move the containers without any material or mechanical interface that comes between the conveyor surfaces and the container surfaces. Unless the conveyor is full, it is capable of immediately receiving a container for transport. For these, and other, reasons, conveyors may provide a very high throughput AMHS.

It would be advantageous to provide a conveyor system that improves the performance of a conventional conveyor and reduces the costs of AMHS conveyor systems. The present invention provides such a conveyor.

### SUMMARY

Asynchronous conveyors as used in semiconductor Automated Material Handling Systems (AMHS) in factories are constructed from numerous zones that are mechanically capable of transport of a carrier in either direction. In practice, users choose to run them in one direction only to avoid the possibility of deadlock conditions. For a single branch of one-directional track this results in the need to move all carriers in one direction to be “cleared.”

In applications, such as sorting, where test wafers are used in transactions for multiple jobs on the same machine, the carrier containing the test wafers must be returned by non-continuous conveyor means. This could be an OHT which picks it up from the “downstream” end and returns it to the “upstream” end, or an expensive alternate routing of conveyor.

Currently the algorithms that control the directionality of the conveyor change the entire conveyor unit direction at one time. This can lead to long delays for individual jobs.

The embodiments of the present invention define an algorithm (method) for administering bidirectionality in regions of zones on a conveyor, where said regions are redefined periodically based on pairwise analysis of adjacent carriers. The method is scalable and generic, and the method can be used identically for any single-branch topology of any size with any number of intermediate destinations.

Advantages include, for example but without limitations, quick changes of directionality in local regions, avoiding excessive wait time for a carrier sitting waiting for conveyor direction change (access), and can resolve all possible cases of pairwise interaction so no deadlock conditions can results. Also, it is noted that any “bucket-brigade” with autonomous sections that are individually bidirectional, such as a set of robots in a row, say direct EFEM-to-EFEM handoff of wafers, could also use this algorithm.

### BRIEF DESCRIPTION OF THE DRAWINGS

The invention, together with further advantages thereof, may best be understood by reference to the following description taken in conjunction with the accompanying drawings.

FIGS. 1-10 define examples of containers traveling along a direction of a conveyor, and destined for destinations, and enabling simultaneous use of the conveyor by more than one conveyor, in accordance with examples of the present invention.

### DESCRIPTION

Embodiments of the present invention will become apparent from the following detailed description, taken in conjunction with the accompanying drawings, illustrating by way of example the principles of the invention.

To describe a system of logical control for carriers moving on a conveyor, allowing carriers to move in opposing directions simultaneously. That conveyor is made up of independently controllable zones, each able to move in either direction. The goal of this motion is to deliver carriers to various entities (tools, stockers, ports, etc.) able to remove them from the conveyor.

The conveyor control is handled at several different levels, each making different types of decisions. LEVEL 1 actually moves the foups, being concerned with directional regions and avoiding collisions. LEVEL 2 resolves adjacent carrier-pair interactions by defining regions and instructing carriers to move to other regions. LEVEL 3 is concerned with assigning carriers to destination entities and communicating with those destination entities. All logic and decision making in this system is handled by the conveyor.

### Terminology

### Downstream/Upstream

One direction of movement is defined as the typical (default) direction, the way things normally will flow. This is designated the downstream direction, and carriers moving downstream will typically have priority over those moving upstream, the opposite direction, although other priority-setting functions are possible.

### Holding Area

The conveyor needs access to at least one holding area to temporarily store carriers. This could be a position in a buffer, a spur line of conveyor, or anything else that can move a carrier so it does not block the main conveyor line.

### Jurisdiction

The conveyor's jurisdiction (span of control) includes all carriers on the conveyor itself, as well as any carriers temporarily stored in a holding area provided for the conveyor's use.

### Region

To help resolve conflicts on the conveyor, the conveyor is divided into a number of regions. In each region, all movement is restricted to either one direction or the other, with no opposing movement allowed, and with no carrier movement into or out of the region allowed. These regions are dynamically defined by LEVEL 2 as needed.

### Carrier Information

The conveyor stores information about each carrier, describing its current state with regards to the conveyor. Carrier information fields are shown in a monospaced font herein. These informational fields are:

location

end destination

current destination

### Control Levels

Level 3

LEVEL 3 is in charge of communication with the factory controllers and destination entities (tools, stockers, etc.) attached to the conveyor. It queries the factory controllers and destination entities to find out which carriers they are requesting. It then considers each carrier in the conveyor's jurisdiction, looking for unallocated carriers matching the request criteria. It then allocates as many of those carriers as needed to the requesting tool.

Allocating a carrier to a tool includes setting the carrier's end destination to the conveyor position connected to that tool.

Level 2

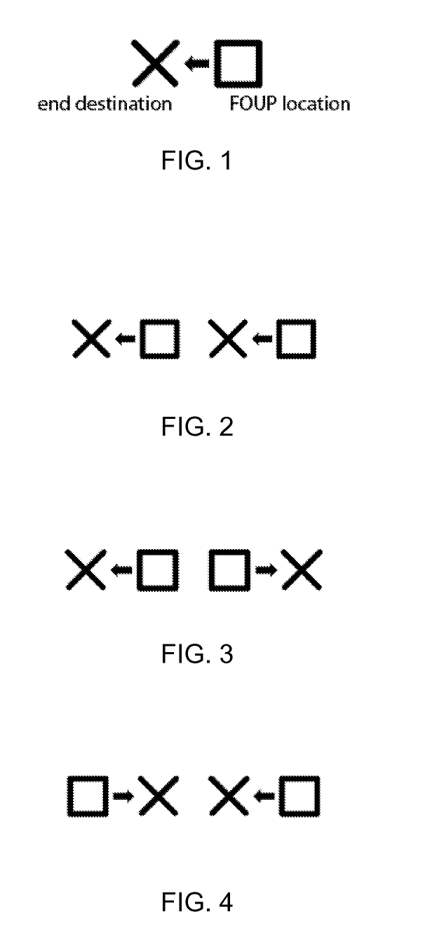

LEVEL 2 looks at the carriers in the conveyor's jurisdiction, sequentially considering adjacent pairs of carriers at a time, their locations and end destinations on the conveyor (see FIG. 1). In the mathematical equations comparing carriers A and B, “<” refers to “upstream”, subscript “p” refers to Present position zone. and subscript “d” refers to Destination position zone.

All adjacent carrier-pair interactions can be described as one of six behavioral cases. Sample illustrations of each are provided below; illustrations of all possible combinations appear at the end of the document.

The Trivial Cases
1) Both carriers are moving in the same direction (See FIG. 2).

(Aₚ>=A_{d} AND Bₚ>=B_{d}) OR (Aₚ<=A_{d} AND Bₚ<=B_{d})
2) The carriers are moving away from each other (See FIG. 3).

A_{d}<=Aₚ AND A_{d}<Bₚ AND B_{d}>=Bₚ AND B_{d}>Aₚ
3) The carriers are moving towards one another, but stopping short of each other's destinations (See FIG. 4).

Aₚ<=A_{d} AND Bₚ>=B_{d} AND A_{d}<B_{d}

### The Region-Resolvable Cases

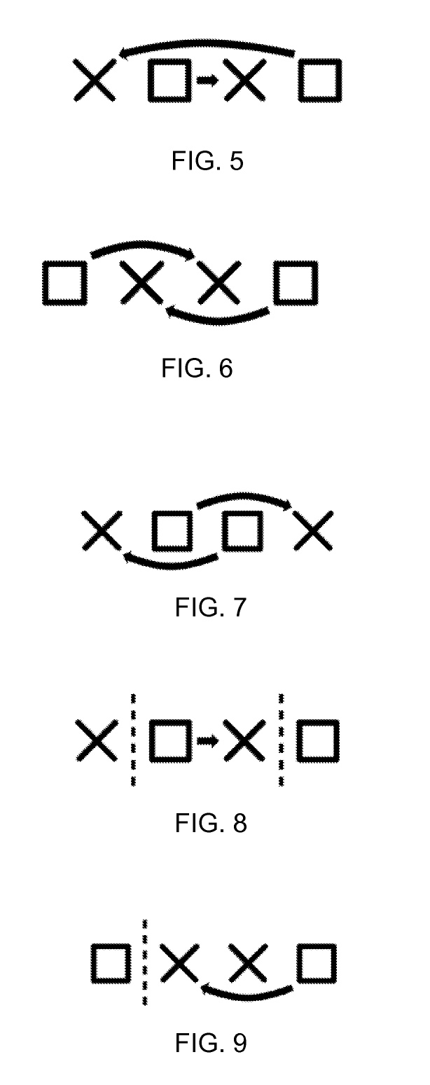

4) One carrier's entire path from location to destination is fully circumscribed by the location and destination of the other (See FIG. 5).

(Aₚ<B_{d} AND Bₚ<=A_{d} AND Bₚ>B_{d}) OR (Bₚ>A_{d} AND A_{d}>Aₚ AND B_{d}<=Aₚ)
5) The carriers are headed towards one another, but must overlap paths to reach their destinations, both of which already lie in the area between the two carriers (see FIG. 6).

Aₚ<B_{d} AND A_{d}>=B_{d} AND A_{d}<Bₚ

### The Region-Unresolvable Case

6) The carriers are headed towards one another, but their destinations are outside the area between the two carriers (See FIG. 7).

B_{d}<=Aₚ AND Bₚ<=A_{d}

LEVEL 2 examines each pair of adjacent carriers and assigns them to one of these six cases as appropriate. It then defines regions of exclusive directionality on the conveyor to allow these cases to resolve themselves. After any carrier moves from one region to another (or is removed from the conveyor jurisdiction), these regions are reevaluated. To resolve these six cases, regions are defined as follows:
1-3) No region control is needed. Carriers are already able to proceed to their destinations with no changes to region directionality definition.
4) LEVEL 2 defines a region around the inner carrier and its destination to prevent the outer carrier from interfering (until the inner carrier reaches its destination and the regions are reassigned) (See FIG. 8).
5) One of the carriers must be allowed to move, while the other is prevented from moving. To do so, LEVEL 2 defines a region around one carrier and its destination. Ordinarily, the carrier moving downstream will be given priority in this resolution, but other priority functions could be applied (such as considering lateness of delivery, etc.) (See FIG. 9).
6) This case in unresolvable by any combination of autonomous regions, so the carriers must be moved by other means. Two methods of resolution present themselves:
   a) Sending one or both carriers to a holding area.
   b) Having one or both carriers back up (that is, move in the opposite direction from its destination) on the conveyor until the pairwise interaction no longer belongs to case 6.

Both of these methods are implemented (temporarily) by redefining the carriers' current destinations, either to the holding area, or to a conveyor position that causes the carrier to back up. Additional considerations could help decide which approach is more efficient in a given circumstance.

In addition, if the conveyor is currently storing carriers in the holding area, LEVEL 2 attempts to move them out. To see if release is possible, it considers the held carrier as if it were on the conveyor, at the position where the holding area would deposit it, provided that that position is not currently occupied. Then LEVEL 2 considers the carrier's pairwise interactions, favoring the held carrier over carriers still on the main conveyor. If this evaluation results in allowing movement of the held carrier, that carrier's current destination is set to the conveyor loading position of the holding area, and the carrier is released from the holding area. For each carrier in the conveyor's jurisdiction, LEVEL 2 has assigned it a current destination. That destination is the same as the carrier's end destination unless the carrier is or was part of a case 6 pairwise interaction.

Level 1

LEVEL 1 only deals with carriers actually on the conveyor, not those in the holding area. It looks at the locations and current destinations of each carrier to see if it can move. Its goal is to move the carrier one step closer to its current destination.

It moves the carrier one step if the following conditions are both true:

1) The regions set by LEVEL 2 allow such a movement.

2) The (intermediate zone) space being moved into is currently unoccupied.

### GLOSSARY OF SELECTED TERMS

Zone: smallest moveable unit of the conveyor. May be a straight zone or a “turn”

Turn: Zone of conveyor that allows directionality change. May have more than one choice of exit

Region: convex (connected) collection of zones that are assigned by the LEVEL 2 algorithm controller to be monodirectional until the next reassignment of that region

Carrier: Any payload on the conveyor or container.

FOUP: Special case of carrier; Front Opening Unified Pod

End Destination Entity (usually a tool or stocker) that removes the carrier from the conveyor jurisdiction, or can insert it into the conveyor jurisdiction.

Tool: Entity that performs a function on the contents of a carrier

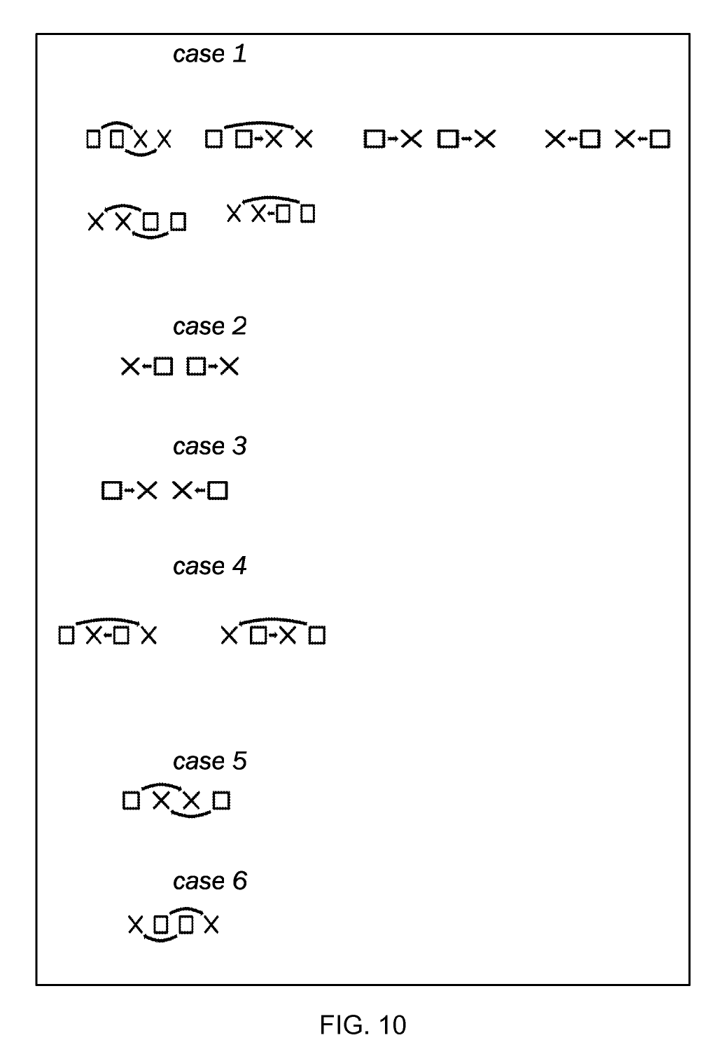

FIG. 10 shows example Illustrations of Possible Pair Interactions, without limitations to other permutations or combinations.

As previously discussed, the conveyors can include integrated networked communications. These communications allow individual conveyor segments to be controlled by a computer system via a network. The computer system can also execute software that allows individual FOUPs to be transported and tracked stopped at load ports, stackers, or while on the conveyors.

The invention may be practiced with other computer system configurations including computing devices, hand-held devices, microprocessor systems, microprocessor-based or programmable consumer electronics, minicomputers, mainframe computers and the like. The invention may also be practiced in distributing computing environments where tasks are performed by remote processing devices that are linked through a network. For instance, on-line gaming systems and software may also be used.

With the above embodiments in mind, it should be understood that the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations described herein that form part of the invention are useful machine operations. The invention also relates to a device or an apparatus for performing these operations. The apparatus may be specially constructed for the required purposes, such as the carrier network discussed above, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The invention can also be embodied as computer readable code on a computer readable medium. The computer readable medium may be any data storage device that can store data, which can thereafter be read by a computer system. Examples of the computer readable medium include hard drives, network attached storage (NAS), read-only memory, random-access memory, FLASH based memory, CD-ROMs, CD-Rs, CD-RWs, DVDs, magnetic tapes, and other optical and non-optical data storage devices. The computer readable medium can also be distributed over a network coupled computer systems so that the computer readable code may be stored and executed in a distributed fashion.

Although the foregoing invention has been described in some detail for purposes of clarity of understanding, it will be apparent that certain changes and modifications can be practiced within the scope of the appended claims. Accordingly, the present embodiments are to be considered as illustrative and not restrictive, and the invention is not to be limited to the details given herein, but may be modified within the scope and equivalents of the appended claims. In the claims, elements and/or steps do not imply any particular order of operation, unless explicitly stated in the claims.

What is claimed is:

1. A method for managing flow of containers over asynchronous conveyors used in semiconductor automated material handling systems (AMHS), comprising:
providing a conveyor;
enabling travel of a first container in a first direction on the conveyor;
enabling travel of a second container in a second direction on the conveyor, the second direction being toward the first direction;
determining a destination of the first and second containers; and
directing one of the first or second containers to reverse its direction to enable one of the first or second containers to arrive to its destinations, while minimizing travel or wait time of the first or second containers on the conveyor belt;
wherein the directing enables higher throughput on the conveyor and enables more than one container to travel on the conveyor at the same time.

2. The method of claim 1, wherein the directing is controlled by an algorithm that enables administration of bi-directionality in regions of zones on the conveyor.

3. The method of claim 2, wherein the regions of zones are redefined periodically based on pair-wise analysis of adjacent containers.
